(19) United States
(12) Patent Application Publication
(10) Pub. No.: US 2006/0186326 A1
(43) Pub. Date: Aug. 24, 2006

(54) Wave receiving apparatus and distance measuring apparatus

(76) Inventor: Takashi Ito, Osaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/353,201

(22) Filed: Feb. 14, 2006

(30) Foreign Application Priority Data
Feb. 21, 2005 (JP) 2005-44429

(51) Int. Cl. H01J 40/14

(52) U.S. Cl. 250/234

(57) ABSTRACT

A wave receiving apparatus includes a light receiving element and a lens for condensing a reflected light toward the light receiving element. The lens has at least three portions that are different from one another in focal length. The lens has at least three portions that are different in focal length, and can input a stable amount of light to the light receiving element in a wide range.

### BACKGOURND OF THE INVENTION

1. Field of the Invention

The present invention relates to a wave receiving apparatus for receiving a wave such as an lightwave, an electromagnetic wave, or an acoustic wave, and to a distance measuring apparatus. The distance measuring apparatus emits a wave such as an lightwave, an electromagnetic wave, or an acoustic wave toward an object to be measured, receives the wave reflected from the object to be measured, and measures a distance on the basis of a traveling time of the wave from an instance of the wave emitted to the instance received back from the object.

2. Description of the Related Art

As an optoelectronic detection device used in a laser distance measuring apparatus, for example, U.S. Pat. No. 6,759,649 discloses a device including a light receiving element 101, a lens 102 that condenses light onto the light receiving element 101, a laser diode 103 that is arranged in the vicinity of the central portion of the lens 102, a lens 104 that is equipped in the center of the lens 102 and collimates the light that has been emitted from the laser diode 103 into collimated light, and a slant mirror 105 that is disposed in front of the lens 104, as shown in FIG. 6.

The light that has been emitted from the laser diode 103 is collimated into collimated light 106 when passing through the lens 102, and then illuminates onto the object to be measured (not shown) through the slant mirror 105. The light 107 that has been reflected by the object to be measured passes through the slant mirror 105 to be condensed by the lens 102, and enters the light receiving element 101. In measuring distances, a period of time elapsed between the emission and the reception of the light is obtained on the basis of a phase difference between a projected light signal 108 that is input to the laser diode 103 to be driven and a received light signal 109 that has been converted by the light receiving element 101, and the obtained period of time is multiplied by a light velocity to calculate a distance to the object to be measured.

In the above conventional distance measuring apparatus, when the distance to the object to be measured from the lens 102 is sufficiently long, as shown in FIG. 6, the light 107 that has been reflected from the object to be measured is collimated into substantially collimated light to be input to the lens 102, and focused by a predetermined focal length of the lens 102 to be input to the light receiving element 101. However, when the distance of from the lens 102 to the object to be measured decreases, the light 107 that has been reflected by the object to be measured is input to the lens 102, as shown in FIG. 7. When the light that has been reflected by the object to be measured enters the lens 102 while being widened, the focal point of the light that passes through the lens 102 is displaced to a position farther than the light receiving element 101, as shown in FIG. 7.

Also, in the above conventional distance measuring apparatus, a retro reflector may be used as an object to be measured. As shown in FIG. 8, the retro reflector becomes higher in the light reflection power as the observation angle approaches 0, and lower in the light reflection power as the observation angle increases. In the case where the above retro reflector is used, when the distance between the lens 102 and the object to be measured decreases, and the light that has been reflected by the object to be measured enters the lens 102 while being widened, light that is low in light reflection power enters an outer diameter portion of the lens 102, and the focal point is displaced from the light receiving element 101 as shown in FIG. 7. For that reason, most of the light does not enter the light receiving element 101. Also, the light that passes through a portion close to the center of the lens 102 is blocked by the lens 104 that is disposed in the vicinity of the center portion of the lens 102, and therefore cannot be input to the light receiving element 101. As a result, as shown in FIG. 9, when the distance to the object to be measured is shorter than a predetermined distance, a sufficient amount of light is not input to the light receiving element 101.

As described above, in a structure in which the lens 104 and the laser diode 103 are disposed in the center portion and in the vicinity of the center portion of the lens 102 that condenses the light onto the light receiving element 101, when the distance to the object to be measured is shorter than a predetermined distance, there may be a case in which the distance cannot be measured. Also, not only in a case in which light such as a laser beam is used but also in cases in which various waves such as an electromagnetic wave or an acoustic wave are respectively used, the same phenomenon may be caused.

### SUMMARY OF THE INVENTION

The present invention has been made in view of the above problems with the conventional art, and therefore an object of the present invention is to provide a wave receiving apparatus in which a wave is input to wave receiving means in a wide range in the case where an obstacle that blocks the progression of the wave exists in the center portion or in the vicinity of the center portion of a lens that condenses the wave.

That is, the wave receiving apparatus includes: wave receiving means for receiving a wave; and a lens for condensing the wave toward the wave receiving means, in which the lens has at least three portions that are different from one another in focal length.

According to the wave receiving apparatus, since the lens has at least three portions that are different from one another in focal length, it is possible to input the waves to the wave receiving means in a wide range with respect to a distance to the wave source.

Also, a distance measuring apparatus includes: wave receiving means for receiving a wave; a lens for condensing a wave toward the wave receiving means; wave emitting means for emitting the wave toward an object to be measured; and distance deriving means for deriving a distance to the object to be measured based on a traveling time of the wave from an instance of the wave emitted to the instance received back from the object, in which the lens has at least three portions that are different from one another in focal length.

The distance measuring apparatus has the wave receiving apparatus of the above-described structure, and can measure a distance to an object to be measured in a wider range.

### BRIEF DESCRIPTION OF THE DRAWINGS

In the accompanying drawings:

FIG. 1 is a diagram showing a distance measuring apparatus according to an embodiment of the present invention;

FIG. 2 is a plan view showing a lens used in a wave receiving apparatus and the distance measuring apparatus according to the embodiment of the present invention;

FIG. 3 is a diagram showing the distance measuring apparatus according to the embodiment of the present invention;

FIG. 4 is a graph showing a relationship between a distance to a reflector and the amount of light that is input to a light receiving element in the distance measuring apparatus according to the embodiment of the present invention;

FIG. 5 is a cross-sectional view showing a lens used in a wave receiving apparatus and a distance measuring apparatus according to another embodiment of the present invention;

FIG. 6 is a diagram showing a conventional optoelectronic detection device;

FIG. 7 is a diagram showing the conventional optoelectronic detection device;

FIG. 8 is a graph showing a relationship between an observation angle and a light reflection power; and

FIG. 9 is a diagram showing a relationship between a distance to the reflector and the amount of light that is input to the light receiving element in a conventional laser distance measuring device.

### DETAILED DESCRIPTION OF THE PREFERRED EMBODIMENTS

Now, a description will be given of preferred embodiments of the present invention with reference to the accompanying drawings.

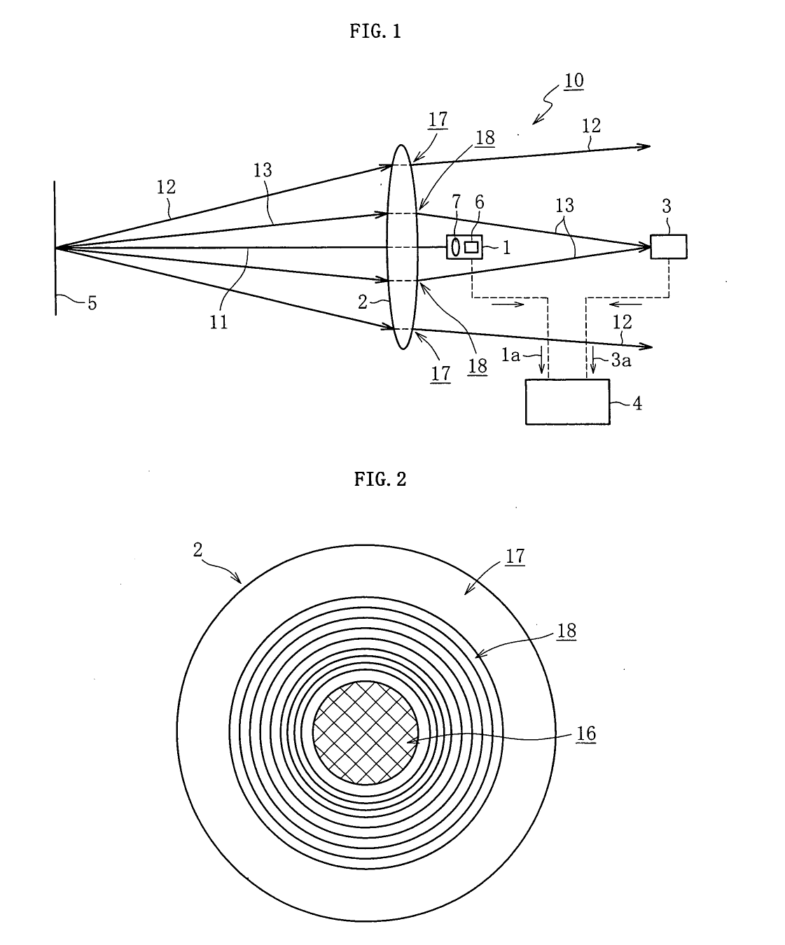

A distance measuring apparatus 10 according to an embodiment of the present invention is so designed as to measure a distance to an object to be measured by using a laser beam. As shown in FIG. 1, the distance measuring apparatus 10 includes a projector 1 as wave emitting means, a lens 2, a light receiving element 3 as wave receiving means, and distance deriving means 4. In FIG. 1, reference numeral 5 denotes a reflector as an object to be measured. In this embodiment, the lens 2 and the light receiving element 3 constitute a wave receiving apparatus. The light receiving element 3 is arranged on the center line of the lens 2 at a position apart from the lens 2 by a predetermined distance. The projector 1 is arranged between the lens 2 and the light receiving element 3 so as to be in the vicinity of the center portion of the lens 2.

The projector 1 includes a laser diode 6 and a lens 7. The laser diode 6 emits laser beam whose amplitude is modulated with a given frequency according to an input signal. Light emitted by the laser diode 6 is collimated into collimated light 11 through the lens 7 to be passed through the lens 2, and is then output to the reflector 5 that is an object to be measured. In this embodiment, although not shown, the light that has been output by the laser diode 6 is received and subjected to photoelectric conversion by the light receiving element provided in the laser diode 6 through an optical fiber, thereby obtaining a projected light signal 11a of the light 11 that has been output from the laser diode 6.

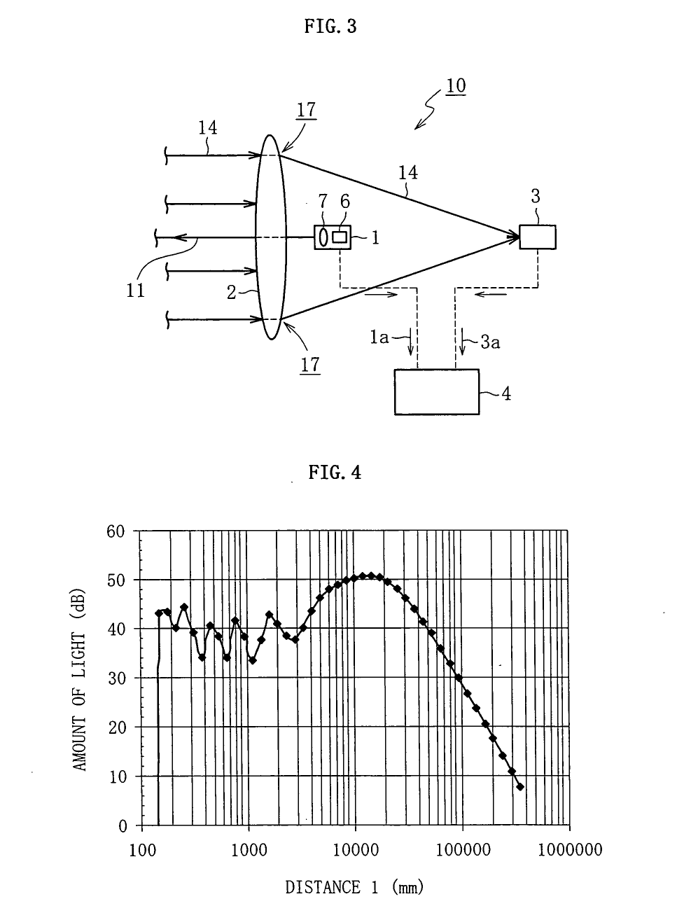

The lens 2 condenses light beams 12 and 13 that have been reflected by the reflector 5 toward the light receiving element 3, and includes at least three portions that are different from one another in focal length. In this embodiment, as shown in FIG. 2, the lens 2 includes, in the center portion thereof, a transmission portion 16 for transmitting the light which is output from the projector 1. As shown in FIG. 3, an outer diameter portion 17 of the lens 2 is formed with a predetermined focal length so as to condense incident collimated light 14 onto the light receiving element 3. An inner diameter portion 18 of the lens 2 has plural concentric portions shorter in the focal length than the outer diameter portion 17 of the lens 2, and the focal lengths are gradually reduced from the outer side toward the inner side.

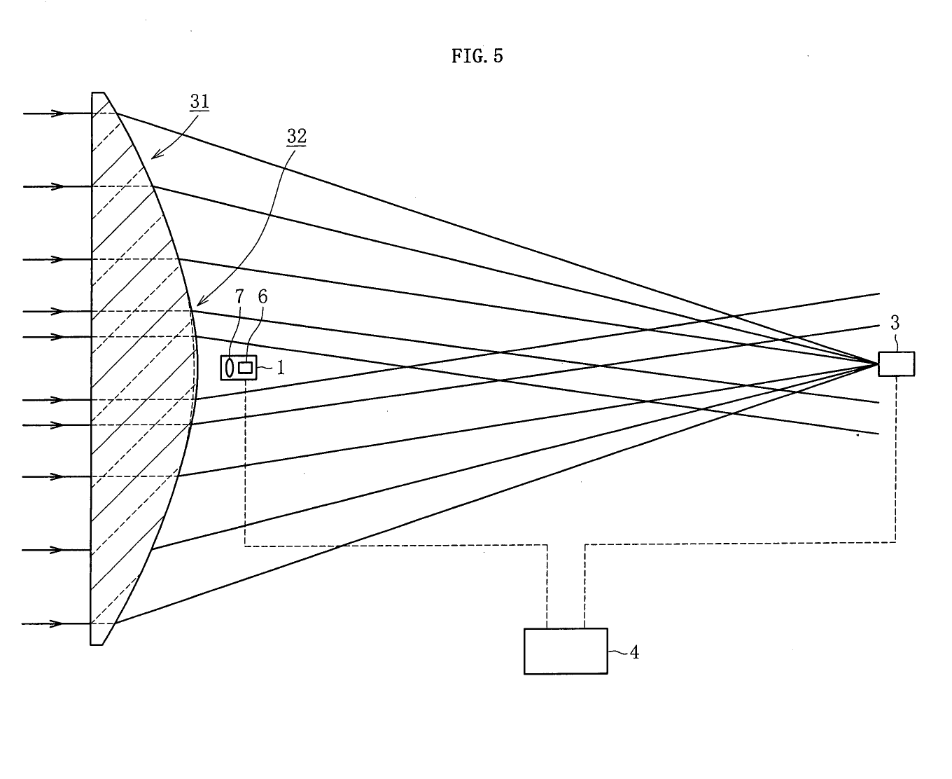

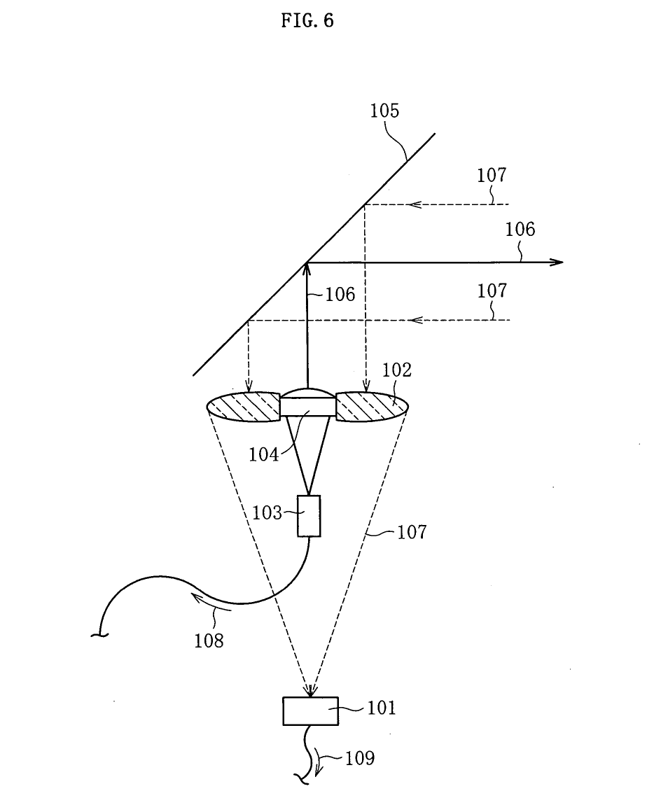

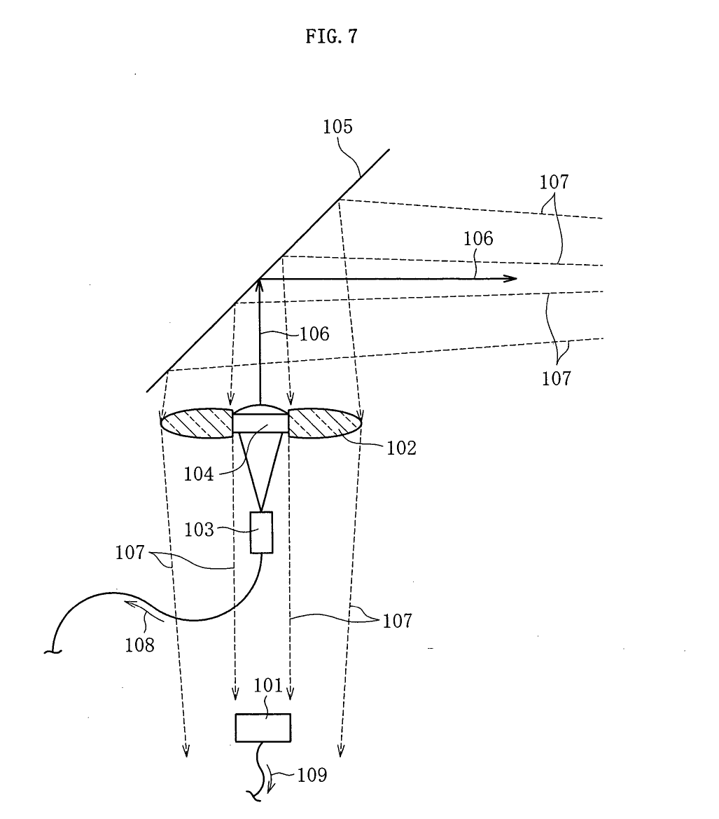

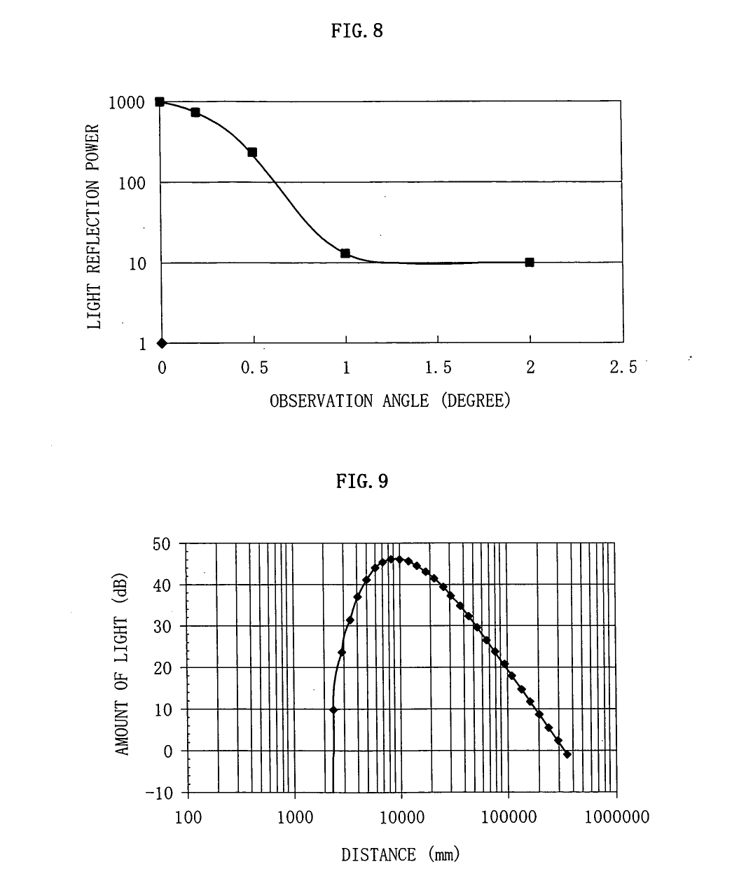

The inner diameter portion 18 of the lens 2 has the focal lengths gradually reduced from the outer side toward the inner side. For that reason, as shown in FIG. 1, when the distance of the reflector 5 decreases, and the reflected light enters the lens 2 while being widened, the light 12 that has passed through the outer diameter portion 17 of the lens 2 does not enter the light receiving element 3, but the light 13 that has passed through the inner diameter portion 18 of the lens 2 enters the light receiving element 3. Also, when a retro reflector is used for the reflector 5, the light 13 that enters the inner diameter portion 18 of the lens 2 becomes higher in light reflection power than the light 12 that enters the outer diameter portion 17 of the lens 2 (refer to FIG. 13). As shown in FIG. 4, the use of the lens 2 makes it possible to input the light 13 that enters the inner diameter portion 18 of the lens 2 to the light receiving element 3 even if the distance to the reflector 5 is decreased. As a result, even in the case where the retro reflector is used for the reflector 5, the stable amount of light can be input to the light receiving element 3 without any deterioration of the light reflection power of the light that enters the light receiving element 3.

Upon receiving the light, the light receiving element 3 subjects the received light to photoelectric conversion to output a received light signal.

The distance deriving means 4 measures a distance on the basis of a traveling time of the wave from an instance of the wave emitted to the instance received back from the object. The traveling time can be measured by the phase difference between the emitted wave and the received wave through the lens. In this embodiment, the distance deriving means 4 measures a distance to the object, based on a phase difference between the wave that is emitted from the wave emitting means 1 and the wave that is reflected by the object to be measured to be input to the wave receiving means 3 through the lens. Specifically, The distance deriving means 4 obtains a phase difference between the light 11 that has been output by the laser diode 6 and the light 12 (13) that has been reflected by the reflector 5 to be input to the light receiving element 3, on the basis of a projected light signal la of the light 11 that has been output from the laser diode 6 and a received light signal 3a that has been output by the light receiving element 3. Then, the distance deriving means 4 calculates a period of time elapsed between the emission of the light 11 from the laser diode 6 and the input of the light 11 to the light receiving element 3. Then, the distance deriving means 4 multiplies the period of time by the light velocity, to thereby obtain a distance to the reflector 5.

According to the distance measuring apparatus 10, in the case where the distance to the reflector 5 is sufficiently long, as shown in FIG. 3, the reflected light 14 that is substantially collimated enters the lens 2, and the light that has passed through the outer diameter portion 17 of the lens 2 enters the light receiving element 3. Also, the inner diameter portion 18 of the lens 2 that condenses the light onto the light receiving element 3 is gradually reduced in focal length toward the inner side from the outer side. As a result, in the case where the distance to the reflector 5 decreases, and the reflected light enters the lens 2 while being widened, as shown in FIG. 1, the light 13 that has gradually passed through the inner diameter portion 18 of the lens 2 is input to the light receiving element 3. As a result, even if the distance to the reflector 5 is shorter, it is possible to obtain information necessary for distance measurement from the light that is input to the light receiving element 3. As described above, the wave receiving apparatus can attain a distance measuring apparatus which is capable of inputting the stable amount of light to the light receiving element 3 in a wide range, and which is wide in a range where the distance can be measured. Also, the use the above wave receiving apparatus makes it possible to dispose the projector 1 in the vicinity of the center portion of the lens 2, thereby enabling the distance measuring apparatus to be downsized.

The wave receiving apparatus and the distance measuring apparatus according to one embodiment of the present invention was described above, and an applied example and a modified example will be described below.

For example, in the above embodiment, the inner diameter portion of the lens is exemplified by an arrangement of plural concentric portions that are shorter in focal length than the outer diameter portion of the lens, in which the focal length is gradually reduced from the outer side toward the inner side. However, it is sufficient that the lens have at least three portions that are different in focal length, and is not limited to the above embodiment. For example, the inner diameter portion of the lens may be divided into plural portions such that each of the portions has a fan-like form, and the focal lengths of the respective portions may be are made different from one another in such a manner that the focal lengths are gradually reduced.

Also, as shown in FIG. 5, a lens 31 has portions that are different in focal length in an inner diameter portion 32 of the lens 31, and the focal lengths are gradually reduced toward the inner diameter side to be smoothly continued in boundary areas of portions where the focal lengths of the inner diameter portion 32 of the lens 31 are different from one another. Since the boundaries are substantially eliminated on the portions that are different in the focal length in the lens 31, the amount of light that enters the light receiving element can be stabilized. Also, there was described an example in which the projector is arranged in the vicinity of the center portion of the lens. However, the present invention is not limited to this arrangement.

The lens may have one portion in which a collimated wave that has been input to the lens is condensed onto the wave receiving means and at least two portions that are shorter in focal length than the one portion and different in focal length from each other. Also, the lens may have a portion, in the outer diameter portion thereof, for condensing the collimated wave that has been input to the lens onto the wave receiving means, and at least two portions, in the inner diameter portion thereof, which are shorter in focal length than the outer diameter portion of the lens and different from one another in focal length.

For example, a portion for condensing the collimated wave that has been input to the lens onto the wave receiving means is disposed in the outer diameter portion of the lens, and at least two portions that are shorter in focal length than the outer diameter portion of the lens and different in focal length from each other are disposed in the inner diameter portion of the lens. In this structure, in the case where the wave source is sufficiently far, and the collimated light is input to the lens, the waves that have passed through the outer diameter portion of the lens can be condensed onto the wave receiving means. Also, in the case where the wave source approaches the lens and the focal point of the wave that has been input to the outer diameter portion of the lens is so displaced as to be far from the wave receiving means, the wave that has passed through the inner diameter portion of the lens which is shorter in focal length than the outer diameter portion of the lens can be condensed onto the wave receiving means. Also, since the inner diameter portion of the lens has at least two portions that are different in focal length, a range in which the wave can be condensed onto the wave receiving means is wide. Also, even in the case where an obstacle that blocks the progression of the wave exists in the center portion or in the vicinity of the center portion of the lens that condenses the wave onto the wave receiving means, the wave receiving apparatus can stably condense the wave onto the wave receiving means.

Also, a portion for condensing the collimated wave that has entered the lens onto the wave receiving means is disposed in the outer diameter portion of the lens, and at least two portions that are shorter in focal length than the outer diameter portion of the lens and different from each other in focal length are disposed in the inner diameter portion of the lens. In this structure, in the case where the distance to the object to be measured decreases, and the reflected wave enters the lens while being widened, the wave enters the inner diameter portion of the lens becomes higher in the light reflection power than the wave that enters the outer diameter portion of the lens. In the case where the distance to the object to be measured decreases, and the reflected wave enters the lens while being widened, the distance measuring apparatus inputs the wave that passes through the inner diameter portion of the lens to the wave receiving means. As a result, even in the case where the distance to the object to be measured decreases, information necessary for distance measurement can be obtained from the wave that has been input to the wave receiving means, and the distance to the object to be measured can be measured in a wider range.

Also, the distance measuring apparatus is exemplified by the laser distance measuring apparatus using a laser beam. However, the wave receiving apparatus and the distance measuring apparatus according to the present invention are capable of being applied to not only a case in which light such as a laser beam is used, but also cases in which various waves such as an electromagnetic wave or an acoustic wave are respectively used.

For example, in the case of using an electromagnetic wave that is very high in the frequency which is called “microwave”, it is preferable that the optical lens in the above embodiment be replaced with a dielectric lens that can control the progressive direction of the electromagnetic wave in the same manner that the optical lens controls an lightwave. The dielectric lens refracts the electromagnetic wave in the dielectric lens due to a difference in dielectric constant. The present invention can be applied to a case where the electromagnetic wave is used by adopting the dielectric lens that are partially different in focal length due to the above known phenomenon. Also, the projector as the wave emitting means can be replaced with a microwave transmitter, and the light receiving element as the wave receiving means can be replaced with a microwave receiver.

Also, the present invention can be applied to a case of using an acoustic wave due to air oscillation. In this case, the optical lens in the above embodiment may be replaced with an acoustic lens that can control the progressive direction of the acoustic wave in the same manner that the optical lens controls an lightwave. For example, in the case of the acoustic wave, the progression rate of the acoustic wave is changed due to a difference in the air density in the same manner as above. In other words, when there is a spatial area that is high in air density, it is known that the acoustic lens exerts a same influence upon an acoustic wave as the lens exerts upon an lightwave. The present invention can be applied to a case where the acoustic wave is used by adopting the acoustic lens that is partially different in focal length due to the known phenomenon. Also, the projector as the wave emitting means can be replaced with an acoustic transmitter, and the light receiving element as the wave receiving means can be replaced with an acoustic receiver.

The wave receiving apparatus and the distance measuring apparatus according to the present invention have been described with reference to the accompanying drawings. However, the wave receiving apparatus and the distance measuring apparatus according to the present invention are not limited to those embodiments.

1. A wave receiving apparatus, comprising:
wave receiving means for receiving a wave; and
a lens for condensing the wave toward the wave receiving means,
wherein the lens has at least three portions that are different from one another in focal length.

2. A wave receiving apparatus according to claim 1, wherein the lens includes a portion for condensing a collimated wave which is input to the lens onto the wave receiving means, and at least two portions that are shorter in focal length than the portion and different from each other in focal length.

3. A wave receiving apparatus according to claim 2, wherein the lens has the portion for condensing the collimated wave which is input to the lens onto the wave receiving means at an outer diameter portion of the lens, and the at least two portions that are shorter in focal length than the outer diameter portion of the lens and different from each other in focal length at the inner diameter portion of the lens.

4. A wave receiving apparatus according to claim 1, wherein boundary areas of the portions that are different in focal length on the inner diameter side of the lens are smoothly continuous to one another in focal length.

5. A distance measuring apparatus, comprising:
wave receiving means for receiving a wave;
a lens for condensing a wave toward the wave receiving means;
wave emitting means for emitting the wave toward an object to be measured; and
distance deriving means for deriving a distance to the object to be measured based on a traveling time of the wave from an instance of the wave emitted to the instance received back from the object,
wherein the lens has at least three portions that are different from one another in focal length.

6. A distance measuring apparatus according to claim 5, wherein the lens includes a portion for condensing a collimated wave which is input to the lens onto the wave receiving means, and at least two portions that are shorter in focal length than the portion and different from each other in focal length.

7. A wave receiving apparatus according to claim 5, wherein the lens has the portion for condensing the collimated wave which is input to the lens onto the wave receiving means at an outer diameter portion of the lens, and the at least two portions that are shorter in focal length than the outer diameter portion of the lens and different from each other in focal length at the inner diameter portion of the lens.

8. A distance measuring apparatus according to claim 5, wherein the lens has the portions that are different in focal length are smoothly continuous to one another in focal length.

9. A distance measuring apparatus according to claim 5, wherein the wave emitting means is disposed in the vicinity of the center portion of the lens.

10. A wave receiving apparatus according to claim 2, wherein boundary areas of the portions that are different in focal length on the inner diameter side of the lens are smoothly continuous to one another in focal length.

11. A wave receiving apparatus according to claim 3, wherein boundary areas of the portions that are different in focal length on the inner diameter side of the lens are smoothly continuous to one another in focal length.

12. A distance measuring apparatus according to claim 6, wherein the lens has the portions that are different in focal length are smoothly continuous to one another in focal length.

13. A distance measuring apparatus according to claim 7, wherein the lens has the portions that are different in focal length are smoothly continuous to one another in focal length.

14. A distance measuring apparatus according to claim 6, wherein the wave emitting means is disposed in the vicinity of the center portion of the lens.

15. A distance measuring apparatus according to claim 7, wherein the wave emitting means is disposed in the vicinity of the center portion of the lens.
